(19) United States
(12) Patent Application Publication
(10) Pub. No.: US 2004/0020087 A1
(43) Pub. Date: Feb. 5, 2004

(54) Color enhancing pin screen

(76) Inventor: Ward Fleming, Palenville, NY (US)

Correspondence Address: HOWARD C. MISKIN, C/O STOLL, MISKIN, & BADIE, THE EMPIRE STATE BUILDING, 350 FIFTH AVENUE SUITE 4710, NEW YORK, NY, 10118, US

(21) Appl. No.: 10/209,460

(22) Filed: Jul. 31, 2002

(51) Int. Cl. G09F 1/00

(52) U.S. Cl. 40/446; 40/427

(57) ABSTRACT

A color enhancing, lightweight, pin screen has multiple polymeric pins, each having a head at one end and slidably positioned in a corresponding aperture in at least one vertically-oriented plate. The polymeric material may be treated to achieve various visual effects, such as phosphorescence in light, black light designs and multiple colors. Also, the shape of the head can be designed to provide various light displays depending on its shape, i.e., convex, concave, diamond, flat and adding a reflective coating.

### BACKGROUND OF THE INVENTION

The invention described herein is designated as a color enhancing pin screen, which provides a multi-purpose entertainment device. It functions as an artistic animation image producer or display by creating varying visual patterns resulting from the selective displacement of a plurality of pins relative to a supporting apertured plate. The pins are individual light pipes from the light source. The pin screen is aesthetically appealing to all ages, and also provides enjoyable participatory entertainment for both children and adults.

Earlier versions of pin screens developed by Applicant wherein metal pins are used are described in U.S. Pat. Nos. 4,536,980 (issued Aug. 27, 1985) and 5,654,989 (issued Apr. 7, 1987). Metal pins are opaque and heavy.

### SUMMARY OF THE INVENTION

In carrying out this invention in one illustrative embodiment thereof, a pin screen for providing a three-dimensional image of an object applied thereto has at least one vertically oriented plate containing a plurality of closely spaced apertures. A plurality of lightweight polymeric pins having heads larger than the apertures are horizontally disposed and are held in their selected positions by frictional engagement in said apertures. The pins form a light pipe of light from the light source at one end to the opposite end. The light pipes formed of the pins can be varied in color, intensity and size by varying the properties of the polymeric material shape of the head and diameter of the pins, and any plating of surfaces of the pins. If the top surface of the head of the pin had a concave surface and coated with a metallic material, the end would reflect light into a point. If the upper surface of the pinhead were made convex and coated with a reflective material, it would diffuse light from the source. The plate has a thickness less than the length of the lightweight polymeric pins exposing the ends and portions of the body of pins, which extend through the plate. The pins are adapted to be selectively axially displaced in said plate when the exposed end portions of the pins that come into contact with an object intended to create a three-dimensional image of the object. The object is pressed against the pins, thereby displacing only those pins in contact with the object and displacing those contacted pins to a depth or extent commensurate with the depth or shape of the object to form a duplicate shape of the object from the opposite ends of those pins displaced. A vertically oriented transparent cover generally parallel to the apertured plate is provided to prevent the pins from falling completely out of the plate head first, if the plate is tipped in that direction. The space between the apertured plate and the cover being less than the length of the pins.

In the preferred embodiment in place of one thick plate, two spaced, thin, parallel plates with aligned horizontal apertures are employed, the space between the two plates being sufficient to maintain axial alignment and movement of the pins. If a single plate is used, it must be thicker to retain the pins in axial displaced position so that the pins will remain parallel when displaced in order to provide an accurate three-dimensional image of the object. In either embodiment, the pins are longer than the separation between the outward facing surfaces of the plate or plates and the transparent cover.

In a further preferred embodiment, a third, vertically oriented, apertured plate is slidably mounted relative to at least one of other plates, to move aligned openings out of registration with respect to the first and second plates and thereby to lock the pins in place to preserve the aforesaid configuration. This embodiment preferably is provided with a locking mechanism of the third plate to preserve the aforesaid configuration during handling of the pin screen.

Another embodiment has the non-headed ends shown in FIGS. 1 and 2 enlarged slightly when axially positioned in the vertically oriented plate or plates, such as by heat, a glue or a material that dissolves the plastic to form a glob. The enlarged ends of the pins are larger than the aligned opening in the vertically oriented plate facing said enlarged ends and prevent the pins from falling out from the vertical plate if the vertical plate is tipped clockwise as illustrated in FIGS. 1 and 2.

### BRIEF DESCRIPTION OF THE DRAWINGS

FIG. 1 is a side elevation view, in section, illustrating an embodiment of the invention in which the pin screen has two vertical apertured plates and the pins are displaced horizontally by an object.

FIG. 2 is a side elevation view, in section, similar to the vertical pin screen of FIG. 1 except this embodiment includes only a single vertically oriented apertured plate.

FIG. 3 illustrates the embodiment shown in FIG. 1 in which a transparent sheet has been added to limit the degree of horizontal displacement of the pins and to retain the pins.

FIG. 4 illustrates the embodiment shown in FIG. 2 in which a transparent sheet has been added to limit the degree of horizontal displacement of the pins and to retain the pins.

FIG. 5 is a perspective view of the pin screen illustrated in FIG. 3 showing a three-dimensional image resulting from the selective horizontal displacement of the pins.

FIG. 6 is a side elevation view, in section, illustrating a further embodiment of the invention in which the pin screen is provided with a locking plate.

FIG. 7 is a fragmentary cross-section of one locking mechanism taken along lines 7-7 in FIG. 6.

### DESCRIPTION OF THE PREFERRED EMBODIMENT

One embodiment of a three-dimensional image-creating pin screen in accordance with the present invention is illustrated in FIGS. 3, 4 and 5 of the drawings.

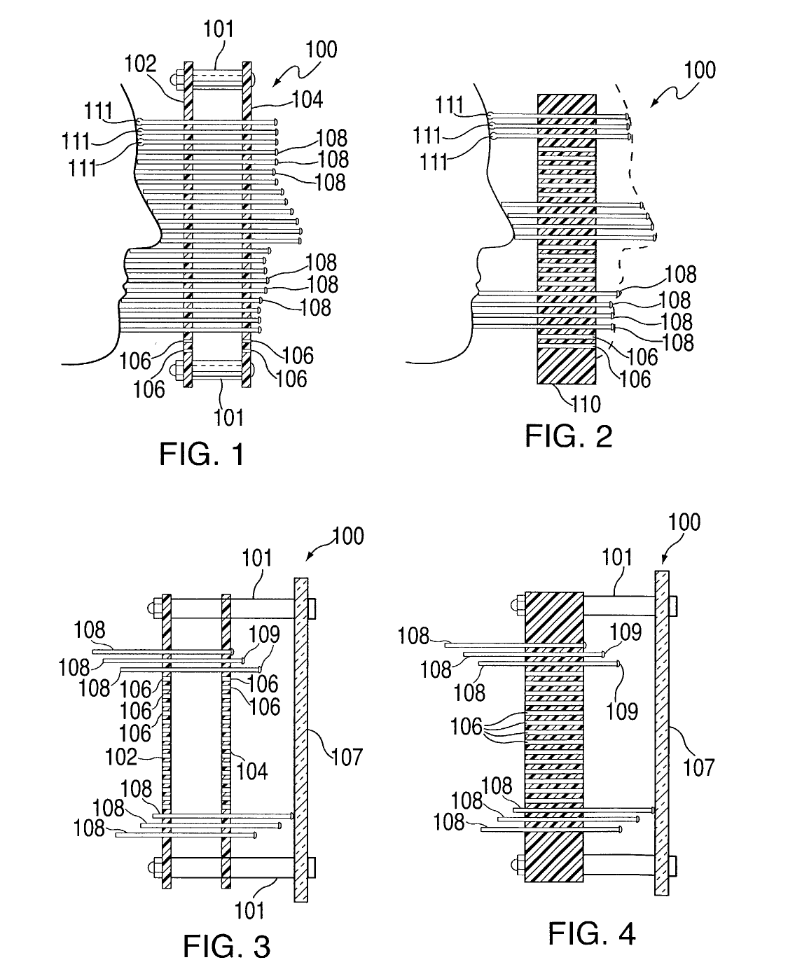

As may be seen from FIG. 1, a vertically orientable housing 100 includes two parallel, spaced apart, vertical apertured plates 102 and 104. Each of the two vertical plates 102 and 104 have horizontally aligned apertures 106 that pass through them with the apertures in one being in axial registration with the apertures in the other plate. The plates are spaced a predetermined distance apart by bolts 101aand spacers 101bgenerally designated by reference numeral 101. As seen in FIG. 1, the spacers 101bare tubes surrounding the shanks of the bolts 101a. A plurality of plastic pins 108 have their shank received in and inserted through the respective aligned openings or apertures 106 defined in both parallel vertical plates 102 and 104. Each of the pins 108 have heads 109, which may be convex and circular in shape. Other geometric configurations may be used for the pin heads 109. The side elevation and top plan configurations of pin heads 109 may be modified to alter the visual effect of the pins. The pin 108 may be provided with multiple components, such as for example, an opaque, centrally-disposed circular core or dot or dots on the head 109 or multiple colored plastic material. Each pin 108 is inserted through one opening in the first plate 102 and the same pin extends to and is inserted through the corresponding horizontally aligned opening in the second plate 104. The spacing between the two vertical plates 102 and 104 is less than the length of pins 108, but sufficient to maintain pins 108 in axial alignment and sliding movement without bending.

To prevent inadvertent displacement of pins 108 from vertical plate 102, the ends of pins 108 opposite pinhead 109 are enlarged by heat, glue or some material that softens or melts the pin material so as to form an enlargement 111 larger than the aperture through which the pin 108 extends. The enlargement 111 may take a variety of forms such as desired, flat, curved convex, concave.

Pin screen housing 100 includes a vertical transparent cover 107 parallel to the plates 102 and 104 and spaced from the facing surface of plate 104, which as shown, is to the right of plate 104. The distance between the facing surfaces of said transparent cover 107 and the apertured plate 102 respectively must be less than the length of the pins. As shown in FIGS. 3 and 4, when the heads 109 of horizontally displaced pins 108 abut against the transparent cover 107, the opposite ends of the pins do not terminate short of the apertured plate 102, thus preventing a user from pushing the pins completely out of the apertured plates. Preferably, the pins 108 are of a length sufficient that the ends of the pins opposite the heads extend slightly beyond or are flush with the outer face of the plate 102. The transparent cover 107 may be a thin glass or plastic sheet and can be supported in vertical position by extended bolts 101a and spacer elements 101b extending from an apertured plate 104.

In these embodiments of the invention, the displaced pins are returned to the initial position (in which the pin heads abut against the right side of the apertured plate 104) by gravitational forces by housing 100 tilting to the left, counter-clockwise, as shown. Also, in the FIG. 1 embodiment, the displaced pins may be returned to the initial position by carefully, physically pushing the pinheads to the left from a position to the right of apertured plate 104.

The embodiments of FIGS. 2 and 4 are substantially identical to the embodiments of FIGS. 1 and 3, respectively, with one exception. Instead of the two relatively thin parallel spaced apart apertured vertical plates 102 and 104 of the FIGS. 1 and 3 embodiments, the FIGS. 2 and 4 embodiments include a single thick apertured vertical plate 110. The thickness of the single plate 110 must be less than the length of the pins and is approximately equal to the separation distance of plates 102 and 104 of the embodiments of FIGS. 1 and 3. The pins are held in axial alignment in the single plate 110 by frictional engagement therewith, and the plate is sufficiently thick (e.g. ½″) relative to the length of the pin shanks (e.g., 3″) to prevent pivoting of the pins and to maintain the horizontal orientation of the pins. The operation and panel of the FIGS. 2 and 4 vertical pin screen embodiments, except as noted herein, are identical to that of FIGS. 1 and 3. Accordingly, corresponding reference numerals have been used for corresponding panel. The pin ends of the embodiment shown in FIG. 2, are enlarged as shown at 111, similar to that shown in FIG. 1.

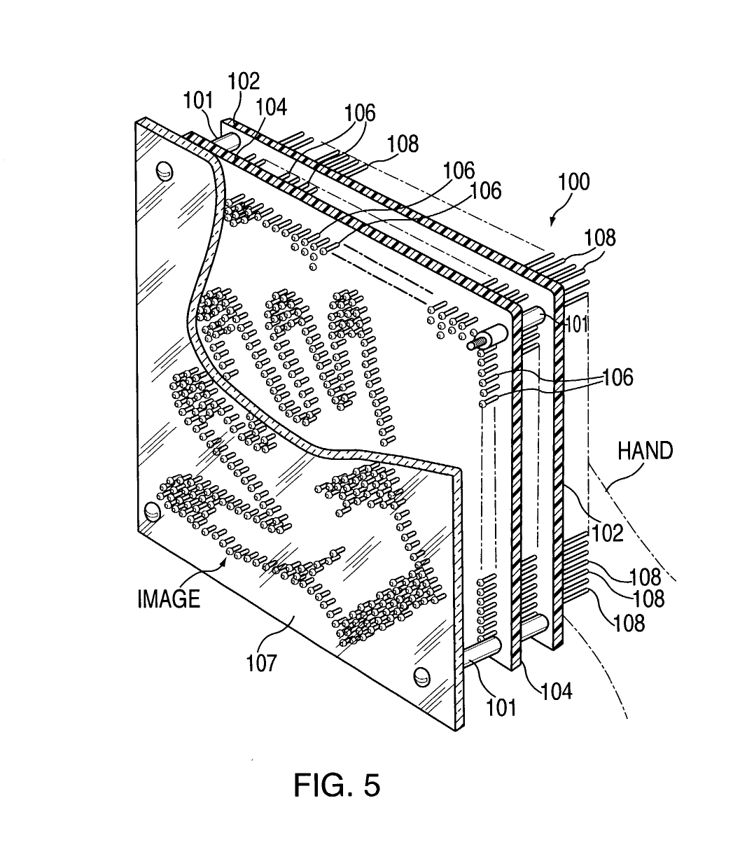

FIG. 5 is a perspective view of the embodiment of the vertical screen of FIG. 3 FIG. 5 shows the three-dimensional configuration of the head ends of the pins as viewed from the right side of any of the embodiments of FIGS. 1-4. FIG. 2 illustrates the making of an exact image of a face. The three-dimensional image of a hand is formed by a horizontal displacement of pin heads resulting from the impression of the image to be reproduced against the ends of the pins extending from the left side of the pin screen illustrated in FIG. 3. This three-dimensional image of the hand created by the displaced head ends of the pins will be retained until the positions of the pins is restored to their initial non-displaced positions in the plates or otherwise varied from the positions illustrated in FIG. 5.

Each pin 108 is composed of a lightweight translucent material, advantageously a lightweight translucent polymeric material, such as nylon, polystyrene or polypropylene. This lightweightness of the pins reduces the cost and weight of the pins 108. The translucent material desirably transmits light throughout the pin and the pin heads, pin shanks and pin ends emit light as light is transmitted through the pin. In this way the pin heads and the pin ends appear as light-emitting dots when light is transmitted through translucent material of the pin 108. Similarly, the pin shanks appear as light-emitting rods, preferably throughout their length.

Because the pins 108 are lightweight, they normally remain in position when they are displaced, rather than sliding out of position upon any slight movement of the unit. Also, the lightweightness of the pin material offers a safety feature since there is a reduced mass for each pin being displaced, such that the impact on displacement is less than a metal pin. This is especially important in use of the pin screen 100 by a child or the face of the user.

In a preferred alternative embodiment, the material of each pin provides fluorescence or phosphorescence to the character of the light emitted from the pin. This may be accomplished by the inclusion of a phosphorescent or fluorescent material to the material of the pin 108. Under exposure to ultraviolet light, the pins fluoresce or glow in the dark. In a further alternative, the pins may be transparent so that the head shapes may be seen through them. Additionally, other variations can be provided by using different color pins in various designs or images.

If the pin is made of a translucent or transparent material, the outer peripheral edge of the pin head will be more translucent or transparent than the central portion of the pin head giving a ringed visual effect to the pin head as light is transmitted through the pin. If the pin head is provided with a centrally-disposed circular dot or core, the center of the pin head will provide a different visual effect than the remainder of the pin head. If the dot or core is opaque, it will provide a pin head with a dot in the center. In this way a pin head may be provided that produces a three intensity color to the pin head. Other combinations of multiple color intensities and/or multiple colors may be provided.

The pins may be different colors or different hues of the same color providing chromatic texture. The different portions of each pin can similarly be different colors or different hues of the same color providing chromatic texture. As mentioned above, the heads can vary in geometric shape and be mixed to provide a different appearance to a formed image.

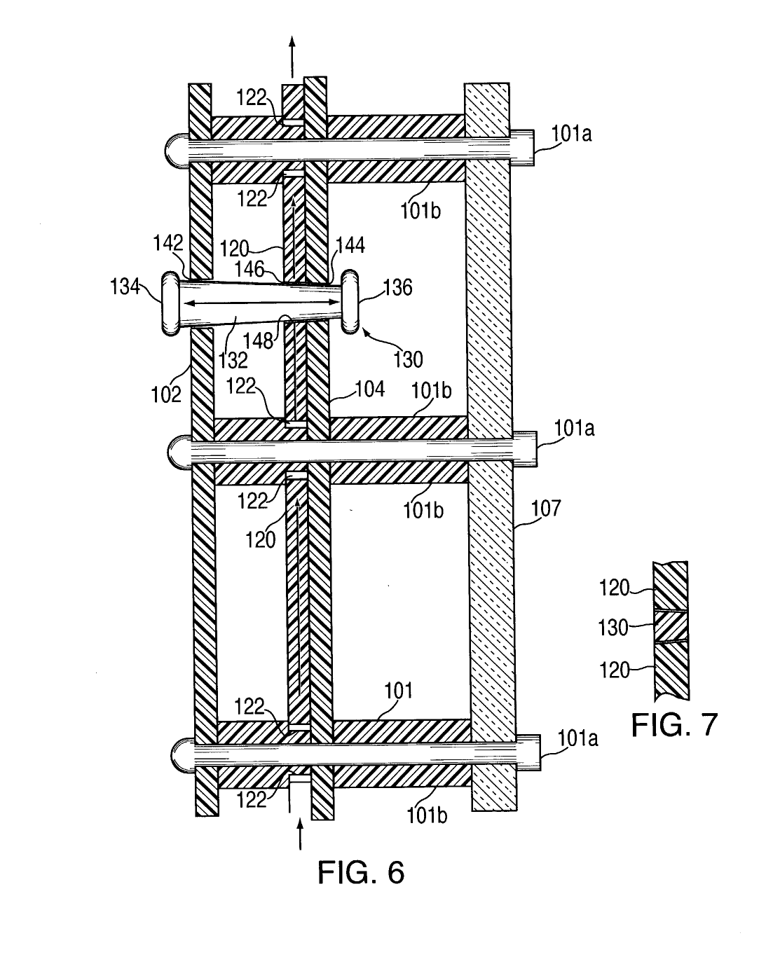

As may be seen in FIG. 6, in an alternative embodiment of the pin screen, another parallel, vertically oriented, apertured plate 120 is interposed between plates 102 and 104 in parallel relation to them. The apertures in this locking plate 120 correspond in placement and alignment to those in the plates 102 and 104. Advantageously, this locking plate is in sliding relation to plate 104 as shown in FIG. 6. In this embodiment, the apertures 122 of this locking plate 120, through which the extended bolts and spacer elements 101 extend, are slotted and the confronting portion of the spacer element has a reduced diameter so that the spacer element retains the locking plate 120 in slidable relationship with respect to the first and second plates 102 and 104. By sliding the locking plate 120 with respect to plate 104, the apertures in plate 120 become out of registry with those of plate 104, the pins 108 are gripped and prevented from axial sliding movement with respect to the plates 102, 104 and 120.

Plate 120 may be locked out of registration with plates 102 and 104 by various means, such as locking pins 130, or cans, not shown. Each locking pin 130 comprises a tapered or wedge-shaped shank 132, the tapered surface being in the direction of movement of plate 120, as shown in FIG. 7. Locking pin 130 has a first head 134 on the larger end of the shank 132 and a second head 136 on the smaller end of the shank 132. Each of the plates 102, 104 and 120 is provided with slots 140. The slots 142 and 144 in plates 102 and 104, respectively, are configured to correspond to the corresponding confronting tapered surface of shank 132. The slot 146 in plate 120 is provided with an edge 148 that is offset inwardly with respect to the longitudinal control axis of the shank 132 so that as the pin 130 is pushed forward into seating relation with the slots 142 and 144 the edge 148 rides against the tapered shank 132 and cams plate 120 with respect to locking pin 130 and slides plate 120 out of registry with plates 102 and 104. This locks the pins 108 in their respective positions and preserves the image that has been made in the pin screen. This locking permits the pin screen, with its reproduced image configuration to be moved without losing that configuration, such as shipping from one place to another. The pin screen, as locked, can be handled and changed in orientation without losing the configuration.

If desired, three or more of the extended bolts of the extended bolts and spacer elements 101 can be extended to exceed the length of the exposed shanks when the shanks fully extend out from the plate 102 to provide legs for the pin screen to sit on when it is horizontally oriented.

As illustrated in FIG. 1, the pins 108 are inserted through the parallel plates such that the respective pin heads 109 are closest to apertured plate 104, while the opposite ends of the pins 108 are closest to the apertured plate 102. The user of the pin screen may selectively displace the pins by pressing an object having a three-dimensional configuration against the pin ends extending through the left side of the plate 102 to horizontally displace pins and pin heads towards the right in FIG. 1. For example, the user may force his face against the pin ends on the left side of plate 102, resulting in pins corresponding to the three-dimensional configuration of the face being displaced towards the right. The horizontally displaced pin heads, when viewed from the right side of the plate 104, recreate a three-dimensional configuration of the object displacing the pins, which in the above example, is the user's face. The pins are held in their displaced positions in the respective apertures in the plates 102 and 104 by frictional engagement between the bodies or shanks of the pins and the apertured plates. The spacing between the two vertical plates is sufficiently great to assure that the horizontally displaced pins 108 will not pivot and slope down significantly below horizontal relative to the two vertical apertured plates, but will remain horizontally oriented.

Preferably, the pins will be about 3 inches in length and the plates will be separated by a distance less than the length of the pins. Preferably, the plates 102 and 104 will be separated by about ½ inch but not more than about 2 ½ inches to allow at least a ½ inch range of horizontal displacement of the pins. The plates may be formed from 22 gauge steel or from phenolic or other rigid plastics. The pin shanks may be about 0.076 inches in diameter and the center-to-center distance of the centers of the apertures in the plates are about 0.160 inches. The aperture diameter will be slightly larger than the diameter of the pin shanks. The pin heads are sufficiently large to prevent the heads from passing through the apertures, preferably about ½ inch. The ends of the pins will be flat, rounded or enlarged such as at 111 to prevent displacement from plates 102 or 110. Pin ends opposite pin head 109 are not pointed to prevent injury or damage to the objects pressed against them for safety concerns. In the preferred embodiment of the vertical pin screen, the spacing of the apertures 106 in each apertured plate is about 0.160 inches center to center. The apertures in the plates can be defined in a staggered row pattern with the alternate rows aligned.

Although certain features of the invention have been illustrated and described herein, other better modifications and changes will occur to those skilled in the art. It is, therefore, to be understood that the appended claims are intended to cover all such modification and changes that fall within the spirit of the invention.

I claim:

1. A vertically orientable pin screen for providing a three-dimensional image of a three-dimensional configuration of an object, said image having enhanced colored, visual content comprising
a. a plurality of pins, each of said pins being composed of a polymeric material comprising either a light-transmissive polymeric material or a colored polymeric material or a light-transmissive colored polymeric material to provide enhanced visual content and having a pin shank with a pin head on one end of said pin shank and a pin end on the other end of said pin shank;
b. a vertically orientable panel with a plurality of apertures therethrough, said apertures being in spaced apart, parallel relation with respect to each other and being horizontally disposed when said panel is in a vertical orientation;
c. each of said pins being disposed in a corresponding one of said apertures with its head abuttable against a common surface of said panel and having the length of its shank sufficient for allowing said pin end portion of the pin shank to project beyond said aperture, said pin head having a maximum transverse dimension grater than the diameter of its corresponding aperture to prevent said pin from passing through said aperture, each of said apertures defining a pathway for sliding translation of said pin disposed therein;
d. each of said apertures having a length sufficient to maintain said pin in a substantially horizontal orientation when said vertically orientable panel is vertically oriented;
e. said vertically orientable panel being adapted to allow selective horizontal displacement of at least some of said plurality of pins relative to said vertically orientable panel when said vertically orientable panel is vertically oriented;
f. said pin heads of said plurality of pins being horizontally displaceable in response to pressing an object having a three-dimensional configuration against said pin end portions projecting beyond said vertically orientable panel causing the displaced heads to create a three-dimensionally configured image of such object;
g. said pins being returnable to their original positions in which their pin heads abut against said vertically orientable panel by gravitational force by tilting said pin screen with the end portions oriented downwardly.

2. A pin screen as claimed in claim 1, wherein said vertically orientable panel comprises
first and second spaced parallel vertically orientable apertured interconnected plates adapted to receive and hold a plurality of pins inserted into the apertures in said two plates;
said respective apertures in said respective plates when said plates are vertically oriented being in horizontal alignment such that a pin inserted through said aligned apertures in each of said plates will be horizontally oriented;
said apertures in each of said plates being aligned in rows;
said rows being with said apertures in alternate rows being aligned with each other;
said apertures being slightly larger than the shanks of said pins;
said shanks being inserted through aligned apertures in said first and second plates with said heads abutting against said first plate,
said first and second plates being spaced apart from each other a distance less than the length of said pin shanks inserted through said apertures in said plates for allowing the end portions of the shanks to project beyond said second apertured plate when said pin heads are abutting against said apertured plate, said spacing of said plates being sufficient to maintain said pins inserted through said aligned apertures in said respective plates in a substantially horizontal orientation when said plates are vertically oriented, said plates being adapted to allow selective horizontal displacement of said pins relative to said plates when said plates are vertically oriented;

3. A pin screen as claimed in claim 2, wherein said vertically orientable panel comprises a transparent cover mounted in a plane parallel to said first and second apertured plates and being spaced form said first apertured plate, said first apertured plate being disposed between said transparent cover and said second apertured plate, the spacing between said transparent cover and said first apertured plate being less than the length of said pins inserted through said apertured plates for limiting the displacement of said pins in said apertures and preventing the pins falling out of said plates head first.

4. A pin screen as claimed in claim 1, wherein each of said pins is fluorescent.

5. A pin screen as claimed in claim 1, wherein each of said pins is a fluorescent color.

6. A pin screen as claimed in claim 1, wherein each of said pins is phosphorescent.

7. A pin screen as claimed in claim 1, wherein each of said pins is a phosphorescent color.

8. A pin screen as claimed in claim 1, wherein each of said pins transmits light throughout the pin.

9. A pin screen as claimed in claim 1, wherein each of said pins emits light.

10. A pin screen as claimed in claim 1, wherein each pin head of each of said pins emits light as light is transmitted through said pin.

11. A pin screen as claimed in claim 1, wherein said pin end of each of said pins emits light as light is transmitted through said pin.

12. A pin screen as claimed in claim 1, wherein said pin shank of each of said pins emits light as light is transmitted through said pin.

13. A pin screen as claimed in claim 1, wherein each of said pins is translucent.

14. A pin screen as claimed in claim 1, wherein each of said pins is transparent.

15. A pin screen as claimed in claim 1, wherein said pin screen further comprises
a vertically oriented, apertured locking plate in parallel relationship to said vertically orientable panel, the apertures in said locking plate corresponding in placement and alignment to the apertures in said vertically orientable panel, said locking plate being slidable with respect to said vertically orientable panel to a position where the apertures in said locking plate are out of registry with the apertures in said vertically orientable panel.

16. A pin screen as claimed in claim 15, wherein said pin screen further comprises at least one locking pin for locking said locking plate out of registration with respect to said vertically orientable panel.

17. A pin screen as claimed in claim 1, wherein said pin end is enlarged greater than the diameter of its corresponding aperture in which it resides.
